(19) United States
(12) Patent Application Publication
(10) Pub. No.: US 2024/0219522 A1
(43) Pub. Date: Jul. 4, 2024

(54) PROCESSING OF MEASUREMENT DATA AVAILABLE AS POINT CLOUDS WITH BETTER GENERALIZATION ACROSS THE TRAINING DATA

(71) Applicant: Robert Bosch GmbH, Stuttgart (DE)

(72) Inventors: Kilian Rambach, Stuttgart (DE); David Stoeckel, Rutesheim (DE); Maxim Tatarchenko, Berlin (DE)

(21) Appl. No.: 18/543,876

(22) Filed: Dec. 18, 2023

(30) Foreign Application Priority Data
Jan. 3, 2023 (DE) 10 2023 200 022.9

(51) Int. Cl. G01S 7/41; G01S 7/48; G01S 7/539

(52) U.S. Cl. CPC G01S 7/417; G01S 7/4802; G01S 7/539

(57) ABSTRACT

A method for processing measurement data which are present as a point cloud of points in space. The point cloud assigns values of one or more measured variables to each point, with regard to a predetermined task. In the method: for each measured variable, all values of the measured variable that are assigned to points of the point cloud are collected and processed to form an aggregated representation. The representation has the same dimensionality irrespective of how many points of the point cloud are assigned values of the relevant measured variable. One or more of these representations are fed as inputs to a task network. The one or more representations are mapped by the task network to the required output with regard to the predetermined task.

### CROSS REFERENCE

The present application claims the benefit under 35 U.S.C. § 119 of German Patent Application No. DE 10 2023 200 022.9 filed on Jan. 3, 2023, which is expressly incorporated herein by reference in its entirety.

### FIELD

The present invention relates to the processing of measurement data available as point clouds, such as radar, lidar or ultrasound data, using neural networks. Such processing can, for example, be aimed at evaluating the measurement data with regard to a predetermined task.

### BACKGROUND INFORMATION

Vehicles that are at least partially automated in traffic are dependent on the constant monitoring of their surroundings in order to be able to react to other road users and their actions on a timely basis. In addition to cameras, radar sensors, for example, which work irrespective of the time of day and weather, are also used for this purpose. Neural networks, which classify the type of recognized objects, for example, are used for evaluation.

The accuracy with which the processing works depends largely on the extent to which the recorded measurement data belongs to the same distribution as the training data. Within this distribution, neural networks generalize well from the training data to measurement data not seen during training.

### SUMMARY

The present invention provides a method for processing measurement data, which are present as a point cloud of points in space. Such a point cloud assigns values of one or more measured variables to each point. Such measured variables can refer to any characteristics of the measurement data. For example, in addition to the signal intensity, which indicates radar cross-section, the distance and/or angle at which the reflection was detected can also be recorded for a radar reflection. Therefore, the measured variables can comprise both directly detected measured variables and derived measured variables that were ascertained from the directly detected measured variables by a signal processing pipeline. The point cloud does not necessarily have to comprise all points for which total values of measured variables were detected. Rather, the point cloud can, for example, only contain those points that have already been identified as belonging to one and the same object by any object recognition method.

According to an example embodiment of the present invention, for each measured variable, all values of this measured variable that are assigned to points in the point cloud are collected and processed into an aggregated representation. Aggregation can be carried out with any function whose result is a function of all values of the measured variable, but does not allow any more conclusions to be drawn about the individual values of the measured variable. The representation has the same dimensionality irrespective of how many points of the point cloud are assigned values of the relevant measured variable. This means that it always comprises the same number of numerical values, irrespective of how many points in the point cloud provide a statement regarding the relevant measured variable.

According to an example embodiment of the present invention, one or more of these representations are fed to a task network as inputs. For this purpose, these representations can, for example, be linked together (concatenated) without loss of information. However, the representations can also be aggregated in any form, for example. The one or more representations are mapped by the task network to the required output with regard to the intended task.

It has been recognized that, in this way, the effects of any fluctuations and uncertainties in the measurement data on the input fed to the task network are suppressed. In particular, aggregation has the effect of suppressing the influence of fluctuations in individual values of the measured variable. The constant dimensionality of the representation, on the other hand, creates robustness against the fact that information regarding individual measured variables is missing for individual points in the point cloud or that points even appear and disappear spontaneously, as is often the case, in particular with radar reflections. A common reason for the lack of information regarding individual measured variables is that the quality of the measurement data recorded by the sensors is too poor for the processing of these measured variables by the downstream signal processing pipeline. For example, an azimuth angle of a radar reflector can only be ascertained very imprecisely if the raw data are noisy. Another reason for missing values of individual measured variables is that, in complex scenarios, the ascertainment of certain derived measured variables by the signal processing chain takes too long and has to be aborted because the radar reflection as a whole has to be delivered at a fixed time. This is comparable to a writer of an exam leaving individual tasks unfinished at the end of the processing time rather than having the whole exam graded as “unsatisfactory” due to late submission.

This robustness indicates that the inputs fed to the task network substantially belong to the same distribution as long as the detected measurement data relate to scenarios with comparable content. For example, measurement data used to detect traffic situations in the vicinity of a vehicle are comparable in terms of content, although there are many different traffic situations and these situations can also occur under a wide range of environmental conditions. Thus, the distribution of measurement data relating to traffic situations is complex, but they can be detected for training the task network. For this purpose, a training data set with training examples can be used that has sufficient variability with regard to all relevant aspects in which the scenarios can differ from one another. For example, it is beneficial for the classification of object types if the training data set contains a sufficient number of training examples for each type in question and if these training examples have also been detected from many different perspectives.

However, random fluctuations in radar data, for example, cannot be detected even with a large set of training examples. Therefore, during the operation of the task network, they always have a tendency to drive the measurement data out of the distribution of the training examples used for training the task network. However, the ability of the task network to generalize to unseen measurement data during training depends largely on the extent to which the unseen measurement data still belong to the distribution of training examples on which the task network was trained. By reducing the influence of random fluctuations on the input of the task network, the accuracy of the output of the task network is ultimately improved.

At the same time, the creation of an aggregated representation for each measured variable also eliminates the requirement that certain measured variables or characteristics must always appear in combination in the measurement data. Thus, each point in the point cloud can provide a statement regarding a measured variable irrespective of whether it can also provide a statement regarding other measured variables. Overall, the information set contained in the point cloud can thus be better utilized, which in turn has a beneficial effect on the accuracy of the statement provided by the task network.

Finally, the fixed dimensionality of the representation also means that further downstream processing by the task network always takes the same amount of time and requires the same amount of memory. This is particularly important in order to be able to provide guarantees for a processing time up to the delivery of the final result within the framework of a real-time system. This can be particularly important for use in vehicles if it is necessary to react to the vehicle environment or changes to it.

The method is somewhat analogous to decision-making processes in companies on the basis of information gathered in a team. The members of the team correspond to the points of the point cloud, the topics of the agenda correspond to the overall detected measured variables, and statements of the team members on the topics correspond to the annotation of certain points of the point cloud with certain values of measured variables. In such a decision-making process, it hardly ever happens that every team member has something substantial to contribute to every topic. Rather, in each case, one or more team members will have gaps in their preparation with respect to individual topics. The management board, which makes the final decision, is not concerned with who was prepared or unprepared for which topic and who could claim what share of the discussion. A jumble of emails in this regard only brings unrest into the system and distracts from the pending decision. For this decision, only the representation of the information prepared by the team in a management board template is relevant.

Pre-processing the point clouds into representations requires only a small amount of computing power and memory. Thus, the resources provided for processing the task network, for example in a control device or other embedded system, do not need to be expanded to enable additional pre-processing.

In a particularly advantageous embodiment of the present invention, the aggregated representation comprises a histogram that assigns the number of points with values of the measured variable in these value ranges to value ranges of the measured variable. A histogram changes only insignificantly if statements from individual points regarding individual measured variables are missing or if individual points are missing completely. Discretization into value ranges (bins) is primarily responsible for this.

The values can be ascertained in particular, for example, by dividing a range in which the collected values of the measured variable move into a predetermined number K of intervals. It is not necessary for all values to lie within one of the K intervals. Rather, the K intervals can also, for example, only cover a subset of the total detected values of the measured variable and values outside this subset can be filtered out as outliers from the outset. The subset can, for example, be in a range of a multiple (about twice) of the standard deviation around the mean value of the relevant measured variable.

In another particularly advantageous embodiment of the present invention, the number K of intervals is optimized as a hyperparameter. Test point clouds and/or validation point clouds are processed into outputs for each value of the hyperparameter. A deviation of the outputs obtained in this way from the target outputs with which the test point clouds or validation point clouds are labeled is then used as feedback for the optimization of the hyperparameter. This can be used, for example, to optimize the pre-processing of the point cloud prior to input into this task network based on a given, fully trained task network in such a way that the influences of random fluctuations are suppressed in the best possible way and the task network can deliver the most accurate result possible.

However, at least one characteristic value of the architecture of the task network can also be optimized as a hyperparameter in order to objectify the embodiment of this architecture. Prior to processing the test point clouds and/or validation point clouds, it may then be necessary to retrain or further train the task network configured according to the value of the hyperparameter with training examples.

In particular, there may be a conflict between the expressive capacity of the task network, on the one hand, and the need for training examples, on the other hand, with regard to the depth of the task network. If the task network is too large in relation to the available set of training examples, it can overfit to these training examples by “misusing” its expressive capacity, i.e., it can “learn by heart” without the potential for generalization. By optimizing the depth of the task network as a hyperparameter, the maximum possible depth at which no overfitting occurs can be ascertained.

In a further particularly advantageous embodiment of the present invention, the aggregated representation comprises one or more static characteristic values of the set of collected values of the measured variable. These characteristic values also change only insignificantly with random fluctuations. The statistical characteristic values can comprise, for example, a mean value and/or a standard deviation or variance. These characteristic values characterize a Gaussian normal distribution. However, any other characteristic values that characterize a different distribution, such as a covariance, can also be used.

In another particularly advantageous embodiment of the present invention, a parameterized distribution function is adjusted to the collected values of the measured variable by varying the parameters. The values of the parameters for which the adjustment is optimal are included in the aggregated representation. This adjustment is also not strongly influenced by fluctuations in individual points of the point cloud.

In particular, the task network can be, for example, a classifier network that maps its input to classification scores with respect to one or more classes of a predetermined classification. For example, the classifier network can contain types of objects whose presence is indicated by the point cloud, or a summary evaluation of the complete scene.

The task network can, for example, be a multilayer perceptron with fully cross-linked layers. These task networks are better suited for processing point clouds than, for example, the convolutional neural networks often used for processing images. In return, they tolerate in particular the sporadic, selective lack of information regarding individual deficiencies. Since the aggregated representations now always have the same dimensionality in each case with regard to the individual measured variables, the lack of individual information no longer affects the dimensionality of the task network input. This eliminates the difficulties associated with the use of fully networked task networks.

The point clouds can, for example, comprise radar reflections, lidar reflections and/or ultrasonic reflections as measurement data. What all these measurement modalities have in common in each case is that they only assign values of one or more measured variables to discrete points, while no values of the measured variables are explained in the spaces between these discrete points.

In another particularly advantageous embodiment of the present invention, the processing of the measurement data is repeated with the proviso that at least one value of a measured variable is not taken into account. From the resulting change in the output of the task network, an importance of the at least one value of the measured variable that was not taken into account is ascertained. Thus, it is possible to investigate the extent to which the point cloud must be modified so that the output delivered by the task network changes significantly. In this way, it is possible to ascertain which measured variables are particularly important for the correct functioning of processing with the task network. The work of the task network becomes easier to explain.

In another particularly advantageous embodiment of the present invention, training point clouds that are labeled with target outputs in relation to the predetermined task are selected as measurement data. Deviations between the ascertained outputs of the task network and the target outputs are evaluated using a predetermined cost function. Task parameters that characterize the behavior of the task network are optimized with the aim of improving the evaluation by the cost function during further processing of training point clouds. Thus, the pre-processing of the point clouds to one or more representations with fixed dimensionality can already be used for training, so that the inputs fed to the task network all belong to a common distribution and this distribution can be learned.

In another particularly advantageous embodiment of the present invention, a control signal is ascertained from the ascertained output of the task network. A vehicle, a driving assistance system, a robot, a system for monitoring regions, a system for quality control and/or a system for medical imaging is controlled with the control signal. In this connection, the improved accuracy of the output of the task network has the effect that the reaction of the relevant controlled system to the control signal is appropriate to the situation embodied in the point cloud of measurement data with a higher probability.

The methods described here according to the present invention can be fully or partially computer-implemented and thus embodied in software. The present invention therefore also relates to one or more computer programs comprising machine-readable instructions that, when executed on one or more computers and/or compute instances, cause the computer(s) and/or compute instance(s) to execute the described method. In this sense, control devices for vehicles and embedded systems for technical devices, which are also capable of executing machine-readable instructions, are to be regarded as computers. Compute instances can be virtual machines, containers or serverless execution environments, for example, which can be provided in a cloud in particular.

The present invention also relates to a machine-readable data carrier and/or a download product comprising the one or more computer programs. A download product is a digital product that can be transmitted via a data network, i.e., downloadable by a user of the data network, and which can be supplied for immediate download in an on-line store for example.

Furthermore, one or more computers and/or compute instances can be equipped with the one or more computer programs, with the machine-readable data carrier or with the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of the method 100 for processing measurement data 1, according to the present invention.

FIG. 2 shows an illustration of the processing from the measurement data 1 to the output 5, 5a-5e of the task network 4, according to an example embodiment of the present invention.

### DETAILED DESCRIPTION OF EXAMPLE EMBODIMENTS

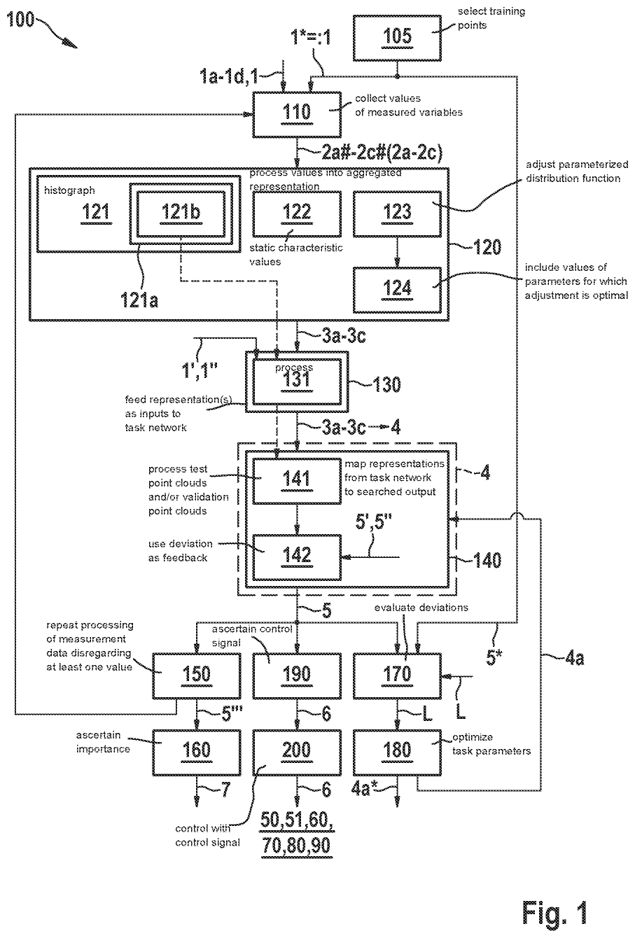

FIG. 1 is a schematic flow chart of an exemplary embodiment of the method 100 for processing measurement data, which is available as a point cloud 1 of points 1a-1d in space, with regard to a predetermined task. The point cloud 1 assigns values 2a#-2c# of one or more measured variables 2a-2c to each point 1a-1d.

In step 110, for each measured variable 2a-2c, all values 2a#-2c# of these measured variables 2a-2c that are assigned to points 1a-1d of the point cloud 1 are collected.

In step 120, these values 2a#-2c# are processed into an aggregated representation 3a-3c of the relevant measured variable 2a-2c.

According to block 121, the aggregated representation 3a-3c can in particular comprise, for example, a histogram that assigns the number of points 1a-1d with values 2a#-2c# of the measured variable 2a-2c in these value ranges to value ranges of the measured variable 2a-2c.

According to block 121a, these value ranges can be ascertained by dividing a range in which collected values 2a#-2c# of the measured variable 2a-2c move into a predetermined number K of intervals. As explained above, the value ranges do not have to cover all collected values 2a#-2c#, but values 2a#-2c# can also be completely disregarded as outliers.

According to block 121b, the number K of intervals, and/or at least one characteristic value of the architecture of the task network 4, can be optimized as hyperparameters.

According to block 122, the aggregated representation 3a-3c can comprise one or more static characteristic values of the set of collected values 2a#-2c# of the measured variable 2a-2c.

According to block 123, a parameterized distribution function can be adjusted to the collected values 2a#-2c# of the measured variable 2a-2c by varying the parameters. The values of the parameters for which the adjustment is optimal can then be included in the aggregated representation 3a-3c in accordance with block 124.

In step 130, one or more of the representations 3a-3c of measured variables 2a-2c are fed as inputs to a task network 4.

In step 140, the one or more representations 3a-3c are mapped from the task network 4 to the searched output 5 with regard to the predetermined task.

According to block 141, when optimizing a hyperparameter, test point clouds 1′ and/or validation point clouds 1″ can be processed into outputs 5 for each value of the hyperparameter. According to block 142, a deviation of the outputs 5 obtained in this way from target outputs 5′, 5′), with which the test point clouds 1′ or validation point clouds 1″ are labeled, can then be used as feedback for optimizing the hyperparameter.

The output 5 provided by the task network 4 can be used in a variety of ways.

For example, in step 150, the processing of the measurement data 1 can be repeated with the proviso that at least one value 2a#-2c# of a measured variable 2a-2c is disregarded. An importance 7 of the at least one disregarded value 2a#-2c# of the measured variable 2a-2c can then be ascertained in step 160 from the resulting change in the obtained output 5′ of the task network 4.

If training point clouds 1* labeled with target outputs 5* with respect to the predetermined task are selected as measurement data 1 according to block 105, deviations of the ascertained outputs 5 of the task network 4 from the target outputs 5* can be evaluated with a predetermined cost function L in step 170. In step 180, task parameters 4a, which characterize the behavior of the task network 4, can then be optimized with the aim of improving the evaluation by the cost function L during further processing of training point clouds 1*. The fully optimized state of the task parameters 4a is designated by the reference sign 4a*.

In step 190, a control signal 6 can be ascertained from the ascertained output 5 of the task network 4. In step 200, a vehicle 50, a driving assistance system 51, a robot 60, a system 70 for monitoring regions, a system 80 for quality control and/or a system 90 for medical imaging can then be controlled with the control signal 6.

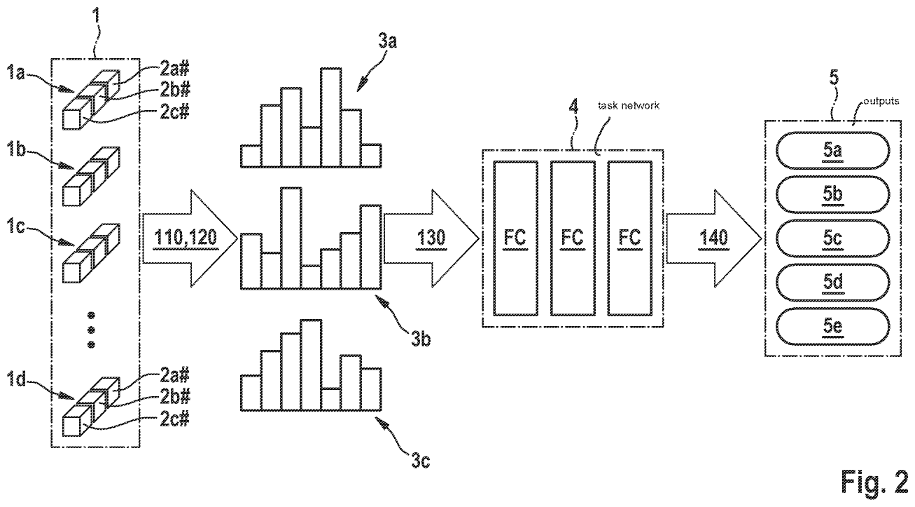

FIG. 2 illustrates the processing method shown in FIG. 1 using the example of a point cloud 1 with four points 1a-1d, which in each case are annotated with values 2a#-2c# of three different measured variables 2a-2c.

For each measured variable 2a-2c, the respective values 2a#-2c# from all points 1a-1d are collected in step 110 of the method 100 and processed in step 120 to form representations 3a-3c of the measured variables 2a-2c, here histograms.

These representations 3a-3c are concatenated in step 130 and fed to the task network 4, which in the example shown in FIG. 2 comprises three fully interconnected layers FC.

In step 150, the task network 4 generates the desired output 5 in relation to the predetermined task. In the example shown in FIG. 2, this task is the classification of the type of object to which the point cloud 1 belongs. Accordingly, the output 5 of the task network 4 comprises input on classification scores 5a-5e with respect to one or more classes of a predetermined classification.

What is claimed is:

1. A method for processing measurement data which are present as a point cloud of points in space, wherein the point cloud assigns values of one or more measured variables to each point, with regard to a predetermined task, the method comprising the following steps:
for each respective measured variable of the one or more measured variables, collecting and processing all values of the respective measured variable that are assigned to points of the point cloud to form an aggregated representation, wherein the representation has the same dimensionality irrespective of how many points of the point cloud are assigned values of the respective measured variable;
feeding one or more of the representations as inputs to a task network; and
mapping, by the task network, the one or more representations to a required output with regard to the predetermined task.

2. The method according to claim 1, wherein each aggregated representation includes a histogram which assigns to value ranges of the respective measured variable, a number of points with values of the respective measured variable in the value ranges.

3. The method according to claim 2, wherein the value ranges are ascertained by dividing a range in which collected values of the respective measured variable move into a predetermined number K of intervals.

4. The method according to claim 1, wherein:
the number K of intervals and/or at least one characteristic value of an architecture of the task network is optimized as a hyperparameter, and wherein:
for each value of the hyperparameter, test point clouds and/or validation point clouds are processed into outputs, and
a deviation of the outputs obtained by the processing from target outputs, with which the test point clouds and/or validation point clouds are labeled, is used as feedback for the optimization of the hyperparameter.

5. The method according to claim 1, wherein the aggregated representation includes one or more static characteristic values of a set of the collected values of the respective measured variable.

6. The method according to claim 1, wherein:
a parameterized distribution function is adjusted to the collected values of the respective measured variable by varying parameters, and
those values of the parameters for which the adjustment is optimal are included in the aggregated representation.

7. The method according to claim 1, wherein the task network is a classifier network mapping its input to classification scores with respect to one or more classes of a predetermined classification.

8. The method according to claim 1, wherein the task network is a multilayer perceptron with fully cross-linked layers.

9. The method according to claim 1, wherein the measurement data include point clouds with radar reflections and/or lidar reflections and/or ultrasonic reflections.

10. The method according to claim 1, wherein:
the processing of the measurement data is repeated with the proviso that at least one value of a measured variable of the one or more measured variables is not taken into account; and
an importance of the at least one value of the measured variable that was not taken into account is ascertained from a resulting change in an obtained output of the task network.

11. The method according to claim 1, wherein:
training point clouds that are labeled with target outputs in relation to the predetermined task are selected as the measurement data;
deviations of ascertained outputs of the task network from the target outputs are evaluated using a predetermined cost function; and
task parameters that characterize behavior of the task network are optimized with an aim of improving the evaluation by the cost function during further processing of the training point clouds.

12. The method according to claim 1, wherein:
a control signal is ascertained from the ascertained output of the task network, and
a vehicle and/or a driving assistance system and/or a robot and/or a system for monitoring regions and/or a system for quality control and/or a system for medical imaging is controlled with the control signal.

13. A machine-readable data carrier on which is stored a computer program including machine readable instructions for processing measurement data which are present as a point cloud of points in space, wherein the point cloud assigns values of one or more measured variables to each point, with regard to a predetermined task, the instructions, when executed by one or more computers and/or compute instances cause the one or more computers and/or compute instances to perform the following steps:
for each respective measured variable of the one or more measured variables, collecting and processing all values of the respective measured variable that are assigned to points of the point cloud to form an aggregated representation, wherein the representation has the same dimensionality irrespective of how many points of the point cloud are assigned values of the respective measured variable;
feeding one or more of the representations as inputs to a task network; and
mapping, by the task network, the one or more representations to a required output with regard to the predetermined task.

14. One or more computers and/or compute instances for processing measurement data which are present as a point cloud of points in space, wherein the point cloud assigns values of one or more measured variables to each point, with regard to a predetermined task, the one or more computers and/or compute instances configured to:
for each respective measured variable of the one or more measured variables, collect and process all values of the respective measured variable that are assigned to points of the point cloud to form an aggregated representation, wherein the representation has the same dimensionality irrespective of how many points of the point cloud are assigned values of the respective measured variable;
feed one or more of the representations as inputs to a task network; and
map, by the task network, the one or more representations to a required output with regard to the predetermined task.
